(19) United States
(12) Patent Application Publication
(10) Pub. No.: US 2022/0086151 A1
(43) Pub. Date: Mar. 17, 2022

(54) PEER REVIEWED ACCESS TO COMPUTING SYSTEM

(71) Applicant: CITRIX SYSTEMS, INC., Fort Lauderdale, FL (US)

(72) Inventor: Jose Reyes, Deerfield Beach, FL (US)

(21) Appl. No.: 17/020,673

(22) Filed: Sep. 14, 2020

(51) Int. Cl. H04L 29/06

(52) U.S. Cl. CPC H04L 63/0884; H04L 63/102

(57) ABSTRACT

A method for peer reviewed authorization may include receiving, from a first client device, a first request for an authorization of one or more actions of a first user at the first client device. The one or more actions may affect a computing system. In response to the first request, a second request for a second user at a second client device to authorize the one or more actions of the first user may be sent to the second client device. A first indication that the second user authorizes the one or more actions may be received from the second client device. The first indication may include an acknowledgement of a threshold quantity of the one or more actions. The one or more actions may be executed at the computing system in response to the first indication. Related systems and articles of manufacture are also provided.

### TECHNICAL FIELD

The subject matter described herein relates generally to computing systems and more specifically to peer reviewed access to a computing system.

### BACKGROUND

Cloud computing can include the on-demand availability of a pool of shared computing resources, such as computer networks, server, data storage, software applications, and services, without direct active management by the user. The phrase can be generally used to describe data centers available to many users over the Internet. Large clouds often have functions distributed over multiple locations from central servers.

Some cloud computing providers can allow for scalability and elasticity via dynamic (e.g., “on-demand”) provisioning of resources on a fine-grained, self-service basis. This can provide cloud computing users the ability to scale up when the usage need increases or down if resources are not being used.

### SUMMARY

Methods, systems, and articles of manufacture, including computer program products, are provided for peer reviewed access to a computing system. In one aspect, there is provided a system including at least one data processor and at least one memory. The at least one memory may store instructions, which when executed by the at least one data processor, cause the at least one data processor to at least: receive, from a first client device, a first request for an authorization of one or more actions of a first user at the first client device, the one or more actions affecting a computing system; respond to the first request by at least sending, to a second client device, a second request for a second user at the second client device to authorize the one or more actions of the first user; receive, from the second client device, a first indication that the second user authorizes the one or more actions, the first indication including an acknowledgement of a threshold quantity of the one or more actions; and respond to the first indication by at least executing, at the computing system, the one or more actions.

In some variations, one or more of the features disclosed herein including the following features can optionally be included in any feasible combination. The data processor may be further caused to at least: in response to the second user at the second client device failing to acknowledge the threshold quantity of the one or more actions, decline to execute, at the computing system, the one or more actions.

In some variations, the data processor may be further cause to at least: receive, from the second client device, a second indication of the second user declining to authorize the one or more actions; and respond to the second indication by at least declining to execute, at the computing system, the one or more actions.

In some variations, the data processor may be further caused to at least: in response to the second user at the second client device failing to respond to the second request within a threshold quantity of time, decline to execute, at the computing system, the one or more actions.

In some variations, the data processor may be further caused to at least: receive, from the second client device, a second indication of the second user terminating the authorization of the one or more actions; and respond to the second indication by at least declining to execute, at the computing system, the one or more actions.

In some variations, the first request may include a request to identify one or more pools of available peer reviewers. The data processor may be further caused to at least: in response to a selection of a pool of available peer reviewers that includes the second user and a third user, send, to the second client device and a third client device of the third user, the second request to authorize the one or more actions of the first user.

In some variations, the first request may include a request to identify one or more available peer reviewers. The second request may be sent to the second client device in response to a selection of the second user from the one or more available peer reviewers.

In some variations, the data processor may be further caused to at least: receive, from the first client device, a third request to access the computing system; respond to the third request by at least sending, to the second client device or a third client device of a third user, a fourth request to verify an identity of the first user; and authenticate, based at least on the second user or the third user verifying the identity of the first user, the first user.

In some variations, executing the one or more actions may modify the computing system including by adding and/or removing one or more of a user and a service of the computing system.

In another aspect, there is provided a method for peer reviewed access to a computing system. The method may include: receiving, from a first client device, a first request for an authorization of one or more actions of a first user at the first client device, the one or more actions affecting a computing system; responding to the first request by at least sending, to a second client device, a second request for a second user at the second client device to authorize the one or more actions of the first user; receiving, from the second client device, a first indication that the second user authorizes the one or more actions, the first indication including an acknowledgement of a threshold quantity of the one or more actions; and responding to the first indication by at least executing, at the computing system, the one or more actions.

In some variations, one or more of the features disclosed herein including the following features can optionally be included in any feasible combination. The method may further include: in response to the second user at the second client device failing to acknowledge the threshold quantity of the one or more actions, declining to execute, at the computing system, the one or more actions.

In some variations, the method may further include: receiving, from the second client device, a second indication of the second user declining to authorize the one or more actions; and responding to the second indication by at least declining to execute, at the computing system, the one or more actions.

In some variations, the method may further include: in response to the second user at the second client device failing to respond to the second request within a threshold quantity of time, declining to execute, at the computing system, the one or more actions.

In some variations, the method may further include: receiving, from the second client device, a second indication of the second user terminating the authorization of the one or more actions; and responding to the second indication by at least declining to execute, at the computing system, the one or more actions.

In some variations, the first request may include a request to identify one or more pools of available peer reviewers. The method may further include: in response to a selection of a pool of available peer reviewers that includes the second user and a third user, sending, to the second client device and a third client device of the third user, the second request to authorize the one or more actions of the first user.

In some variations, the first request may include a request to identify one or more available peer reviewers. The second request may be sent to the second client device in response to a selection of the second user from the one or more available peer reviewers.

In some variations, the method may further include: receiving, from the first client device, a third request to access the computing system; responding to the third request by at least sending, to the second client device or a third client device of a third user, a fourth request to verify an identity of the first user; and authenticating, based at least on the second user or the third user verifying the identity of the first user, the first user.

In another aspect, there is provided a computer program product that includes a non-transitory computer readable medium. The non-transitory computer readable medium may store instructions that cause operations when executed by at least one data processor. The operations may include: receiving, from a first client device, a first request for an authorization of one or more actions of a first user at the first client device, the one or more actions affecting a computing system; responding to the first request by at least sending, to a second client device, a second request for a second user at the second client device to authorize the one or more actions of the first user; receiving, from the second client device, a first indication that the second user authorizes the one or more actions, the first indication including an acknowledgement of a threshold quantity of the one or more actions; and responding to the first indication by at least executing, at the computing system, the one or more actions.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to peer reviewed access to a computing system, it should be readily understood that such features are not intended to be limiting. The claims that follow this disclosure are intended to define the scope of the protected subject matter.

### DESCRIPTION OF DRAWINGS

FIG. 1 depicts a system diagram illustrating an example of a peer reviewed access control system, in accordance with some example embodiments;

FIG. 2 depicts a sequence diagram illustrating an example of a process for user authentication, in accordance with some example embodiments;

FIG. 3 depicts a sequence diagram illustrating an example of a process for peer reviewed authorization, in accordance with some example embodiments;

FIG. 4 depicts a sequence diagram illustrating another example of a process for peer reviewed authorization, in accordance with some example embodiments;

FIG. 5A depicts a flowchart illustrating an example of a process for peer reviewed authentication, in accordance with some example embodiments;

FIG. 5B depicts a flowchart illustrating an example of a process for peer reviewed authorization, in accordance with some example embodiments;

FIG. 6A depicts a network diagram illustrating an example of a network environment, in accordance with some example embodiments;

FIG. 6B depicts a block diagram illustrating an example of a computing device, in accordance with some example embodiments;

FIG. 6C depicts a high-level architecture of an example of a virtualization system for implementing a computing system, in accordance with some example embodiments.

When practical, like reference symbols in the various drawings indicate like elements.

### DETAILED DESCRIPTION

Cloud providers can provide a remote computing environment, for example, with virtual machine (VM) infrastructure such as a hypervisor using native execution to share and manage hardware, allowing for multiple computing environments which are isolated from one another, yet exist on the same physical machine. The computing environment can include an infrastructure as a service (IaaS) platform that provides application programming interfaces (APIs) to dereference low-level details of underlying network infrastructure. In such an infrastructure as a service platform, pools of hypervisors can support large numbers of virtual machines and include the ability to scale up and down services to meet varying needs. Infrastructure as a service platforms can provide the capability to the user to provision processing, storage, networks, and other fundamental computing resources where the user is able to deploy and run arbitrary software, which can include operating systems and applications.

An administrator may access a computing system, such as a cloud or remote computing system, to modify the production environment of the computing system. The administrator may be capable of making a plethora of modifications to the production environment including, for example, the addition and/or removal of one or more users, services, and/or the like. As such, administrative access to the computing environment may be subjected to heightened scrutiny, which may impose a bottleneck delaying the implementation of the modifications made by the administrator. Such delays can adversely affect user experience and create frustration on behalf of users. This is especially true for time sensitive tasks that cannot afford administrative delays. In general, customers expect the modifications made by the administrator to take immediate effect, but this is often not the case. Accordingly, in some example embodiments, administrator access to a computing system may be subject to contemporaneous peer review, which minimizes the delays with verifying the identity of the administrator as well as the modifications made the administrator.

In some example embodiments, administrator access to the computing system (e.g., a cloud or remote computing system) may be subject to peer reviewed authentication in which permission to access the computing system is granted to a first user based at least on a second user authenticating an identity of the first user. For example, peer reviewed authentication may be performed in addition to multi-factor authentication (MFA) and/or biometric authentication. As such, in response to the first user verifying an identity of the first user by performing multi-factor authentication and/or biometric authentication, the second user may be prompted to provide further verification of the identity of the first user. The first user may be granted permission to access to the computing system in response to the second user verifying the identity of the first user.

In some example embodiments, administrator access to the computing system may be subject to peer reviewed authorization in which the computing system executes one or more actions performed by the first user based at least on an authorization from the second user. For example, upon being authenticated to access the computing system, the first user may perform one or more actions but the one or more actions may not be executed at the computing system without authorization from the second user. The second user may authorize the one or more actions of the first user. This authorization may persist as long as the second user acknowledges a threshold quantity of the actions performed by the first user. As such, while the authorization from the second user remains valid, the actions performed by the first user may be executed at the computing system even without the second user acknowledging each individual action. In doing so, the actions performed by the first user may be subject to sufficient oversight with minimal or no delay.

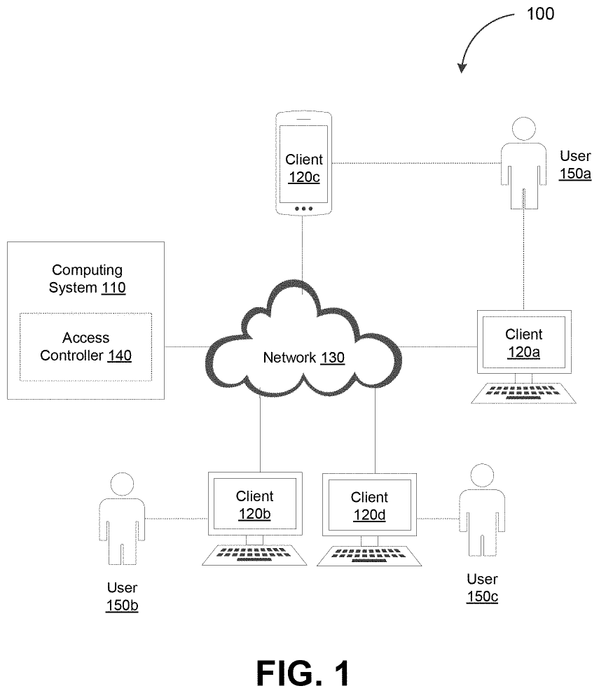

FIG. 1 depicts a system diagram illustrating an example of a peer reviewed access control system 100, in accordance with some example embodiments. Referring to claim 1, the peer reviewed access control system 100 may include a computing system 110, a first client 120a, a second client 120b, a third client 120c, and a fourth client 120d. As shown in FIG. 1, the computing system 110, the first client 120a, the second client 120b, the third client 120c, and the fourth client 120d may be communicatively coupled via a network 130. The computing system 110 may be a cloud computing system and/or a remote computing system accessible to the first client 120a and/or the second client 120b via the network 130. The network 130 may be a wired network and/or a wireless network including, for example, a local area network (LAN), a virtual local area network (VLAN), a wide area network (WAN), a public land mobile network (PLMN), the Internet, and/or the like. The first client 120a, the second client 120b, and the third client 120c may be processor-based devices including, for example, a smartphone, a personal computer, a tablet computer, a wearable apparatus, an Internet-of-Things (IoT) appliance, and/or the like.

Referring again to FIG. 1, the computing system 110 may include an access controller 140 configured to implement peer reviewed access control. For example, in order for a first user 150a at the first client 120a to be granted permission to access to the computing system 110, the access controller 150 may subject the first user 150a to peer reviewed authentication in which the access controller 150 may grant, based at least on a second user 150b at the second client 120b authenticating an identity of the first user 150a, permission for the first user 150a to access to the computing system 110. Upon being granted permission to access to the computing system 110, the first user 150a may perform one or more actions, which may modify the computing system 110 when executed at the computing system 110. As such, the actions performed at the first client 120a, for example, by the first user 150a, may be subjected to peer reviewed authorization. For example, with peer reviewed authorization, the access controller 140 may execute, at the computing system 110, the actions performed at the first client 120a in response to receiving, from the second client 120b, an indication that the second user 150b authorizes actions.

In some example embodiments, access to the computing system 110, including administrator access to modify the computing system 110, may be subject to peer reviewed authentication, which may be performed in addition to multi-factor authentication (MFA) and/or biometric authentication. For example, in response to the first client 120a verifying an identity of the first user 150a by performing multi-factor authentication and/or biometric authentication, the access controller 140 may send, the second client 120b, a request for the second user 150b at the second client 120b to provide further verification of the identity of the first user 150a. The access controller 140 may grant, to the first user 150a, access to the computing system 110 in response to receiving, from the second client 120b, an indication of the second user 150b verifying the identity of the first user 150a.

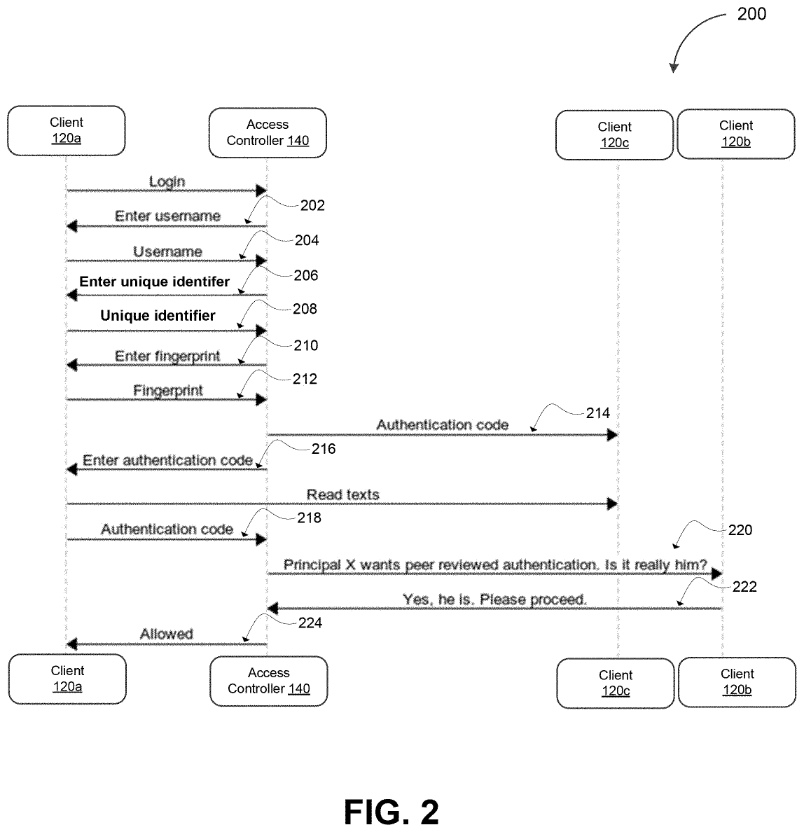

To further illustrate, FIG. 2 depicts a sequence diagram illustrating an example of a process 200 for user authentication, in accordance with some example embodiments. In some example embodiments, the access controller 140 may grant, in response to receiving, from the second client 120b, an indication of the second user 150b authenticating the identity of the first user 150a, permission for the first user 150a at the first client 120a to access the computing system 110. Moreover, as shown in FIG. 2, the peer reviewed authentication may be performed in addition to multifactor authentication (MFA) and/or biometric authentication.

In the example shown in FIG. 2, the identity of the first user 150a may be authenticated based at least on one or more unique identifiers associated with the first user 150a including, for example, a username, a password, a personal identification number (PIN), and/or the like. For example, at 202, the access controller 140 may prompt the first user 150a at the first client 120a to input, at the first client 120a, for a first unique identifier, such as a username, of the first user 150a. At 204, the access controller 140 may receive, from the first client 120a, the username of the first user 150a. In response to receiving the username of the first user 150a, at 206, the access controller 140 may prompt the first client 120a for another unique identifier such as a password or a personal identification number (PIN) of the first user 150a. At 208, the access controller 140 may receive, from the first client 120a, the unique identifier of the first user 150a.

At 210, upon authenticating the first user 150a based on one or more unique identifiers of the first user 150a, the access controller 140 may prompt the first client 120a to provide biometric data of the first user 150a such as, for example, a fingerprint and/or the like. As shown in FIG. 2, at 212, the access controller 140 may receive, from the first client 120a, biometric data (e.g., fingerprint and/or the like) of the first user 150a. Upon authenticating the first user 150a based on the biometric data (e.g., fingerprint and/or the like) received from the first client 120a, at 214, the access controller 140 may perform multifactor authentication including by sending, to the third client 120c of the first user 150a, an authentication code. At 216, the access controller 140 may prompt the first client 120a for the authentication code sent to the third client 120c. At 218, the access controller 140 may receive, from the first client 120a of the first user 150a, the authentication code such that the access controller 140 may further authenticate the first user 150a based on whether the authentication code received from the first client 120a matches the authentication code sent to the third client 120c.

The access controller 140 may, as noted, perform peer reviewed authentication in addition to the biometric authentication and multifactor authentication. Accordingly, the access controller 140 may further authenticate the first user 150a by prompting the second client 120b of a second user 150b to authenticate the identity of the first user 150a. It should be appreciated that the access controller 140 may communicate with the second client 120b of the second user 150b in various manner including, for example, via electronic mail, instant messaging, short message service (SMS), push notifications, and/or the like.

For example, FIG. 2 shows that at 220, the access controller 140 may send, to the second client 120b of the second user 150b, a message requesting verification of the identity of the first user 150a. At 222, the access controller 140 may receive, from the second client 120b of the second user 150b, a message verifying the identity of the first user 150a. In response to the second user 150b verifying the identity of the first user 150a, the access controller 140 may, at 224, grant the first user 150a at the first client 120a permission to access the computing system 110. Contrastingly, if the second user 150b fails to verify the identity of the first user 150a, the access controller 140 may deny the first client 120a access to the computing system 110.

In some example embodiments, upon being granted permission to access to the computing system 110, the first user 150a may perform one or more actions, which may modify the computing system 110 when executed at the computing system 110. As such, the access controller 150 may further subject, to peer reviewed authorization, the actions performed at the first client 120a by the first user 150a. For example, the access controller 140 may execute, at the computing system 110, the actions performed at the first client 120a based at least on the receipt of an indication of authorization of that the second user 150b to allow the first user 150a to access the computing system 110.

In some example embodiments, the second user 150b may become a peer reviewer by consenting to be a peer reviewer. In doing so, the second user 150b may join a pool of peer reviewers that includes, for example, a third user 150c at the fourth client 120d. In order to execute one or more actions at the computing system 110, the first client 120a may send, to the access controller 140, a request peer reviewed authorization. The access controller 140 may respond to the request for peer reviewed authorization by at least notifying one or more of the peer reviewers in the pool of reviewers such as, for example, the second user 150b at the second client 120b, the third user 150c at the fourth client 120d, and/or the like.

The second client 120b (or a different reviewer from the pool of reviewers) may respond to the notification by at least sending, to the access controller 110, an indication that the second user 150b consents to be a peer reviewer for the first user 150a. Based on this consent to be a peer reviewer for the first user 150a, the second client 120b may provide the authorization to execute, at the computing system 110, the one or more actions performed at the first client 120a by the first user 150a. This authorization may persist as long as the second user 150b remains a peer reviewer for the first user 150a. For example, the second user 150b may remain a peer reviewer for the first user 150a by acknowledging a threshold quantity of actions performed by the first user 150a. However, the second user 150b may cease to be a peer reviewer for the first user 150a by failing to acknowledge the threshold quantity of the actions performed by the first user 150a and/or sending, to the access controller 140, an indication terminating the authorization of the actions. The second user 150b may also cease to be a peer reviewer for the first user 150a if the first user 150a fails to perform, at the first client 120a, an action for more than a threshold length of time.

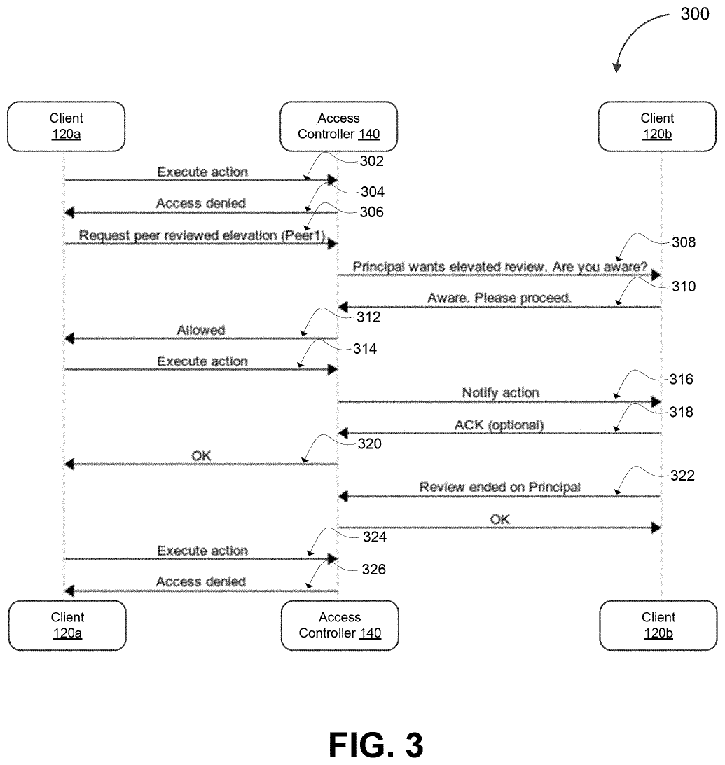

To further illustrate, FIG. 3 a sequence diagram illustrating an example of a process 300 for peer reviewed authorization, in accordance with some example embodiments. At 302, the first client 120a may attempt to perform a first action. When executed at the computing system 110, the first action may modify the computing system 110 by adding and/or removing one or more users, services, and/or the like. At 304, the access controller 140 may respond to the attempt of the first client 120a to perform the first action by denying access to the first client 120a. Accordingly, at 306, the first client 120a may send, to the access controller 140, a request for peer reviewed authorization. In the example shown in FIG. 3, at 308, the access controller 140 may respond to the request for peer reviewed authorization by at least sending, to the second client 120b, a message indicating that the first user 150a requested peer reviewed authorization. As noted, the access controller 140 may also notify other reviewers in the pool of reviewers such as, for example, the third user 150c at the fourth client 120d, and/or the like.

At 310, the second client 120b may respond to the message from the access controller 140 by at least sending, to the access controller 140, a message that indicates consent of the second user 150b to become a peer reviewer for the first user 150a. As shown in FIG. 3, upon agreement of the second user 150b to be a peer reviewer for the first user 150a, the second client 120b may provide authorization for the one or more actions performed at the first client 120a. For example, at 312, in response to the second user 150b becoming a peer reviewer for the first user 150a, the access controller 140 may send, to the first client 120a of the first user 150a, a notification that the one or more actions performed at the first client 120a are allowed to be executed at the computing system 110. At 314, the first user 150a may respond to the notification by at least performing the first action. In response to the first action being performed at the first client 120a, at 316, the access controller 140 may send, to the second client 120b associated with the second user 150b, a notification of the first action performed at the first client 120a.

At 318, the access controller 140 may receive, from the second client 120b of the second user 150b, an acknowledgment of the first action performed by at the first client 120a. In the example shown in FIG. 3, the access controller 140 may, at 320, respond to the acknowledgment from the second user 150b by at least executing, at the computing system 110, the first action. However, as noted, the authorization for the first user 150a to perform the one or more actions may persist as long as the second user 150b remains a peer reviewer for the first user 150a, for example, by acknowledging a threshold quantity of actions performed by the first user 150a. As such, the access controller 140 may execute the first action performed by the first user 150a even if the second user 150b does not acknowledge the first action but remains a peer reviewer for the first user 150a. In doing so, the access controller 140 may ensure that the second user 150b provides sufficient oversight but without imposing unnecessary delays on the execution of the first action at the computing system 110.

Contrastingly, the access controller 140 may not execute a second action performed by the first user 150a if the second user 150b ceases to be a peer reviewer for the first user 150a. For example, the second user 150b may cease to be a peer reviewer for the first user 150a when the second client 120b sends, to the access controller 140, an indication to terminate the authorizations of the actions performed at the first client 120a by the first user 150a. Alternatively and/or additionally, the second user 150b may cease to be a peer reviewer for the first user 150a due to one or more timeout conditions. One example of a timeout may occur when the access controller 140 fails to receive, from the second client 120b, an acknowledgement for a threshold quantity of the actions performed at the first client 120a by the first user 150a. A timeout may also occur when no actions are performed at the first client 120a for more than a threshold length of time.

In the example shown in FIG. 3, at 322, the second user 150b at the second client 120b may cease being a peer reviewer for the first user 150b. The second user 150b may cease to be a peer reviewer for the first user 150b when the second client 120b sends, to the access controller 140, an indication to terminate the authorization of the actions of the first user 150b. Alternatively and/or additionally, the second user 150b may also cease to be a peer reviewer for the first user 150b by failing to acknowledge a threshold quantity of actions performed by the first user 150a, and/or the like. At 324, the first user 150a may perform, at the first client 120a, the second action. When executed at the computing system 110, the second action may modify the computing system 110 by adding and/or removing one or more users, services, and/or the like. In the absence of a peer reviewer for the first user 150a, the access controller 140 may, at 326, decline to execute, at the computing system 110, the second action.

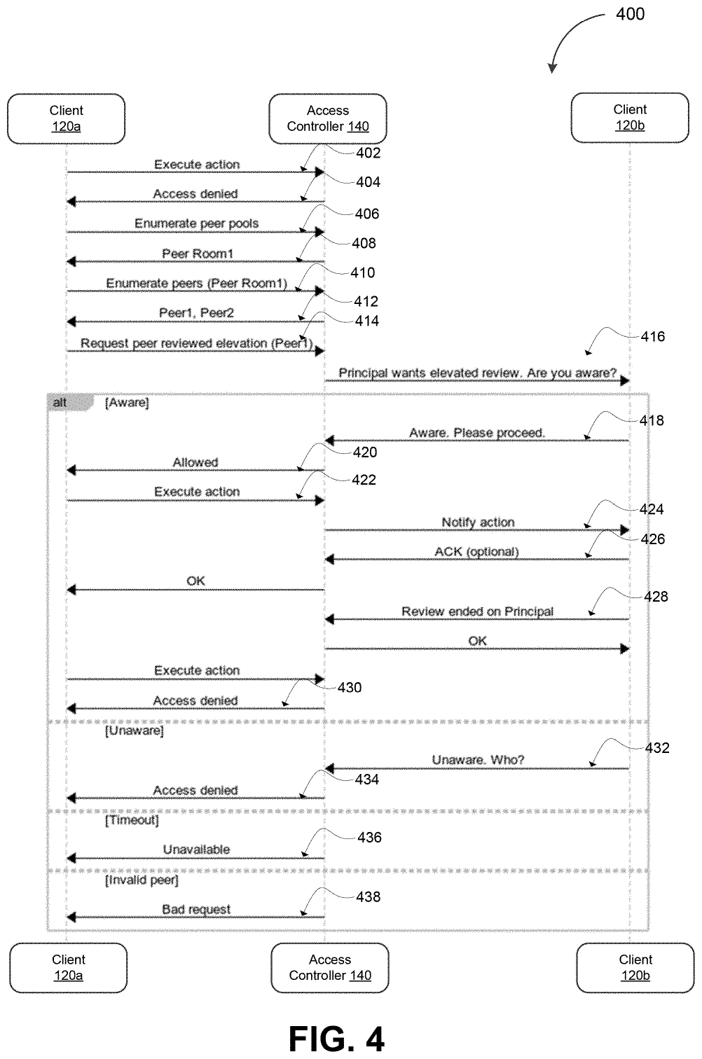

FIG. 4 depicts a sequence diagram illustrating another example of a process 400 for peer reviewed authorization, in accordance with some example embodiments. In the example of peer review authorization shown in FIG. 4, the first client 120a may interact with the access controller 140 in order to enable or otherwise allow the first user 150a to select a pool of peer reviewers as well as a specific peer reviewer, for example, the second user 150b at the second client 120b, to provide the authorization for the first user 150a to perform one or more actions at the computing system 110.

At 402, the first client 120a may perform a first action, which may modify the computing system 110 when executed at the computing system 110. The access controller 140 may respond to the first action being performed at the first client 120a by denying, at 404, access to the computing system 110. At 406, the access controller 140 may receive, from the first client 120a, a request to identify one or more pools of peer reviewers. In response to the request from the first client 120a, at 408, the access controller 140 may send, to the first client 120a, a message identifying the available pools of peer reviewers including, for example, the pool of peer reviewers including the second user 150b and the third user 150c.

At 410, the first client 120a may send, to the access controller 140, a request to enumerate the peers present in one of the available pools of peer reviewers. At 412, the access controller 140 may send, to the first client 120a, a message identifying the peer reviewers present in the pool of peer reviewers including, for example, the second user 150b, the third user 150c, and/or the like. The first client 120a may provide a selection of, at 414, a specific peer reviewer for the first user 150a, for example, the second user 150b at the second client 120b by at least sending, to the access controller 140, a request for peer reviewed authorization by the second user 150b.

Accordingly, at 416, the access controller 140 may respond to the request for peer reviewed authorization by at least sending, to the second client 120b of the second user 150b, a message indicating that the first user 150a requested peer reviewed authorization by the second user 150b. The second client 120b may provide consent of second user 150b to be a peer reviewer for the first user 150a, in which case the access controller 140 may execute, at the computing system 110, the actions performed at the first client 120a as long as the second user 150b remains a peer reviewer for the first user 150a. Alternatively, the second user 150b may fail to consent to being a peer reviewer for the first user 150a, in which case the access controller 140 may decline to execute, at the computing system 110, the actions performed at the first client 120a.

For example, at 418, the second client 120b may indicate consent of the second user 150b to be a peer reviewer for the first user 150a by at least sending, to the access controller 140, a corresponding message. As shown in FIG. 4, upon agreement of the second user 150b to be a peer reviewer for the first user 150a, the second client 120b may provide authorization to the computing system 110 that allows the first user 150a to perform one or more actions. For instance, at 420, the first user 150a may perform, at the first client 120a, a first action, which may modify the computing system 110 when executed at the computing system 110. In response to the first user 150a at the first client 120a performing the first action, at 422, the access controller 140 may send, to the second client 120b associated with the second user 150b, a notification of the first action performed by the first user 150a. At 424, the access controller 140 may receive, from the second client 120b associated with the second user 150b, an acknowledgment of the first action performed by the first user 150a.

In the example shown in FIG. 4, the access controller 140 may respond to the acknowledgment from the second user 150b by at least executing the first action. However, as noted, the authorization for the first user 150a to perform the one or more actions may persist as long as the second user 150b remains a peer reviewer for the first user 150a, for example, by acknowledging a threshold quantity of actions performed by the first user 150a. As such, the access controller 140 may execute the first action performed by the first user 150a even if the second user 150b does not acknowledge the first action but remains a peer reviewer for the first user 150a. However, at 428, the second user 150b may cease to be a peer reviewer for the first user 150a. Accordingly, in response to the first user 150a performing a second action at 428, the access controller 140 may, at 430, deny access to the first user 150a to perform the second action at the computing system 110.

FIG. 4 also depicts scenarios in which the second user 150b fails to consent to being a peer reviewer for the first user 150a, in which case the access controller 140 may decline to execute, at the computing system 110, the actions performed at the first client 120a by the first user 150a. For example, at 432, instead of agreeing to be a peer reviewer for the first user 150a, the second user 150b may send, to the access controller 140, a message declining the request to be a peer reviewer for the first user 150a. As such, at 434, the access controller 140 may deny access to the first user 150a to perform the second action at the computing system 110. Alternatively, at 436, the second user 150b may fail to respond, for example, with in a threshold quantity of time, to the request to be a peer reviewer for the first user 150a. In a third scenario shown in FIG. 4, the access controller 140 may fail to receive, from the first client 120a, an indication identifying a peer reviewer for the first user 150a. In these scenarios, the first user 150a may lack a peer reviewer to provide the authorization necessary to perform one or more actions at the computing system 110. Accordingly, the access controller 140 may decline to execute, at the computing system 110, the actions performed at the first client 120a.

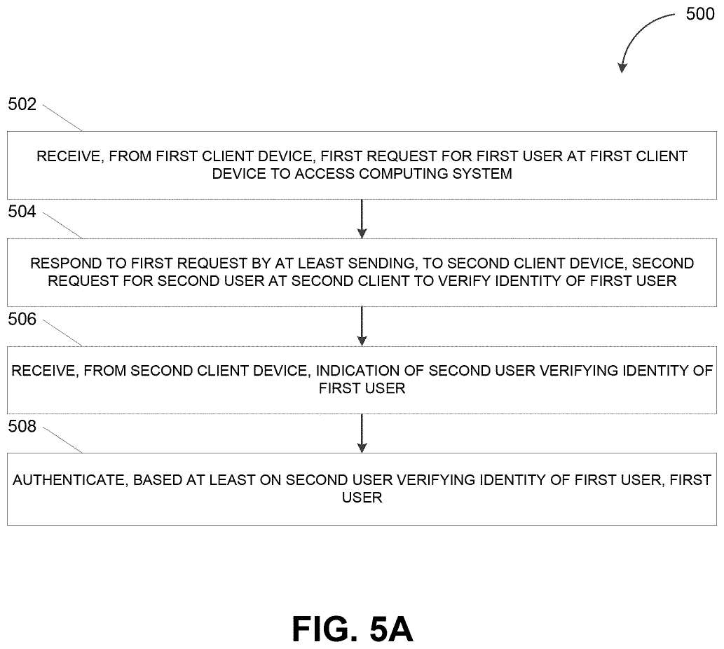

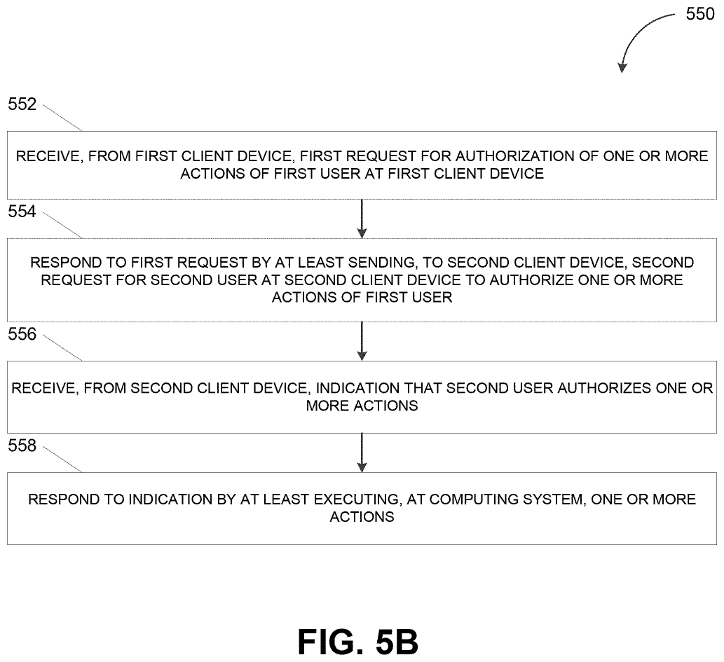

FIG. 5A depicts a flowchart illustrating an example of a process 500 for peer reviewed authentication, in accordance with some example embodiments. Referring to FIGS. 1-2 and 5A, the process 500 may be performed by the access controller 140 in order to authenticate the identity of the first user 150a at the first client 120a such that the first user 150a is able to access the computing system 110.

At 502, the access controller 140 may receive, from a first client device, a first request for to access the computing system 110 on behalf of a first user at the first client device. For example, the access controller 140 may receive, from the first client 120a, a request from the first user 140a to access the computing system 110.

At 504, the access controller 140 may respond to the first request by at least sending, to a second client device, a second request for a second user at the second client device to verify an identity of the first user. In some example embodiments, in order for the first client 120a to gain access to the computing system 110, the access controller 140 may subject the first user 150a to peer reviewed authentication. For example, peer reviewed authentication may include the access controller 140 sending, to the second client 120b of the second user 150b, a request to verify the identity of the first user 150. As noted, the access controller 140 may perform the peer reviewed authentication in addition to and/or instead of multifactor authentication (MFA) and/or biometric authentication.

At 506, the access controller 140 may receive, from the second client device, an indication of the second user verifying the identity of the first user. For example, the access controller 140 may receive, from the second client 120b, an indication that the identity of the first user 150a has been verified by the second user 150b.

At 508, the access controller 140 may authenticate, based at least on the second user verifying the identity of the first user, the first client 120a. For example, the first user 150a may be authenticated based at least on the second user 150b verifying the identity of the first user 150a. Upon authenticating the first user 150a, the access controller 140 may grant the first client 120a access to the computing system 110. Contrastingly, in the event the second user 150a at the second client 120b fails to verify the identity of the first user 150a, the access controller 140 may deny permission for at the first client 120 to access the computing system 110. For instance, the second user 150a at the second client 120b may fail to verify the identity of the first user 150a by failing to respond to the request or by responding to the request with an indication that the second user 150b is unable to verify the identity of the first user 150a.

FIG. 5B depicts a flowchart illustrating an example of a process 550 for peer reviewed authorization, in accordance with some example embodiments. Referring to FIGS. 1, 3-4, and 5B, the process 550 may be performed by the access controller 140 in order to authorize one or more actions performed by the first client 120a for execution at the computing system 110. As noted, the first client 120a may perform the one or more actions. When executed at the computing system 110, the one or more actions may modify the computing system 110 including by adding and/or removing one or more users, services, and/or the like.

At 552, the access controller 140 may receive, from a first client device, a first request for an authorization of one or more actions of a first user at the first client device. For example, the first client 120a may send, to the access controller 140, a request for peer reviewed authorization of one or more actions performed at the first client 120a. When executed at the computing system 110, the one or more actions may modify the computing system 110. As such, the access controller 140 may decline to execute, at the computing system 110, the one or more actions in the absence of peer reviewed authorization.

At 554, the access controller 140 may respond to the first request by at least sending, to a second client device, a second request for a second user at the second client device to authorize the one or more actions requested by the first user. In some example embodiments, the requested actions of the first user 150a may be subject to peer reviewed authorization in order to be executed at the computing system 110. Accordingly, the access controller 140 may respond to the first client 120a requesting authorization of the actions by at least requesting another user, for example, the second user 150a at the second client 120b, to serve as a peer reviewer by providing the authorization required for executing the requested one or more actions. For example, the second user 150b at the second client 120b may become a peer reviewer by consenting to be a peer reviewer and/or joining a pool of peer reviewers. In response to the first user 150a requesting peer review, the access controller 140 may notify one or more of the peer reviewers in the pool of reviewers including, for example, the second user 150b at the second client 120a. As shown in FIGS. 3-4, the first user 150a may request peer review with or without selecting a specific peer reviewer.

At 556, the access controller 140 may receive, from the second client device, an indication of that the second user authorizes the requested one or more actions. In some example embodiments, the access controller 140 may receive, from the second client 120b, an indication that the second user 150b consents to being a peer reviewer for the first user 150a. For example, the second client 120b (or device of a different reviewer from the pool of reviewers) may respond to the notification with at least an indication of consent to be a peer reviewer for the first user 150a. By consenting to be a peer reviewer for the first user 150a, the second client 120a may provide the authorization to execute, at the computing system 110, the one or more actions requested. This authorization may persist as long as the second user 150b acknowledges a threshold quantity of the actions of the first user 150a.

At 558, the access controller 140 may respond to the indication by at least executing, at a computing system, the one or more actions. As noted, the authorization from the second user 150b may persist as long as the second user 150b remains a peer reviewer for the first user 150a, for example, by acknowledging a threshold quantity of actions performed by the first user 150a. The threshold quantity of actions may be a quantity that includes some but not necessarily all of the actions performed at the first client 120b by the first user 150a. Accordingly, the access controller 140 may execute, at the computing system 110, the actions of the first user 150a as long as the second user 150b acknowledges some but not necessarily all of the actions of the first user 150a. The second user 150b may therefore provide sufficient oversight for the actions of the first user 150a without imposing unnecessary delays on the execution of the actions at the computing system 110.

For example, while the second user 150b remains a peer reviewer of the first user 150a, the access controller 140 may execute, at the computing system 110, the actions performed at the first client 120a. Executing these actions may modify the computing system 110 including by adding and/or removing one or more users, services, and/or the like. By contrast, the access controller 140 may decline to execute, at the computing system 110, the actions performed at the first client 120a when the second user 150b ceases to be a peer reviewer for the first user 150a. For instance, the second user 150b may cease to be a peer reviewer for the first user 150a in response to failure of the second user 150b to acknowledge the threshold quantity of actions. Alternatively and/or additionally, the second user 150b may cease to be a peer reviewer for the first user 150a by sending, to the access controller 140, an indication terminating the authorization of the actions of the first user 150a. The second user 150b may also cease to be a peer reviewer for the first user 150a when the first user 150a fails to perform an action at the first client 120a for longer than a threshold length of time.

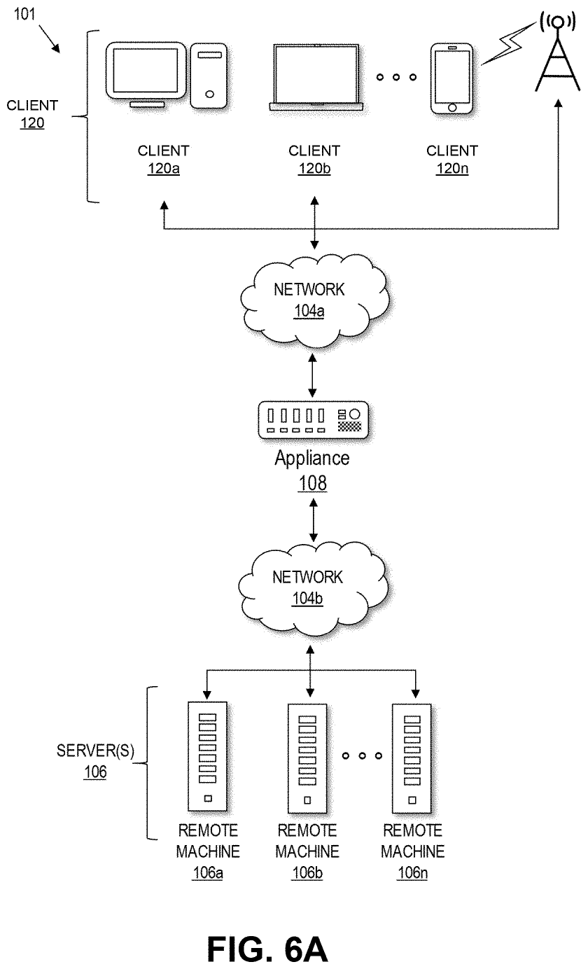

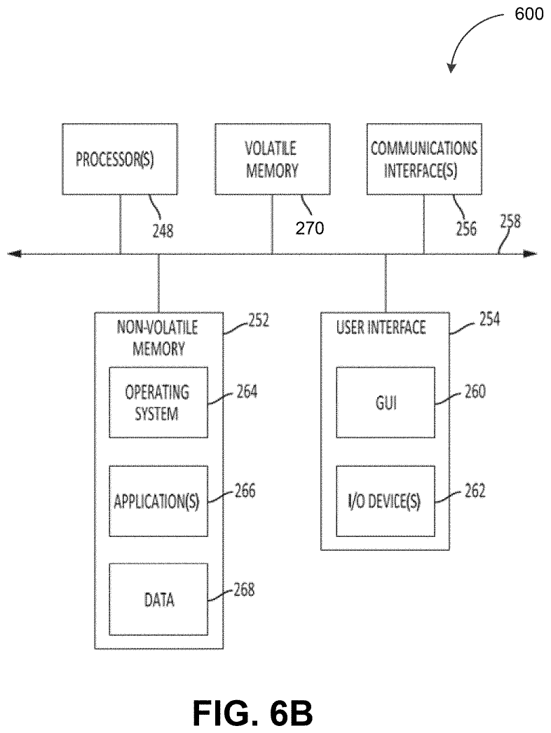

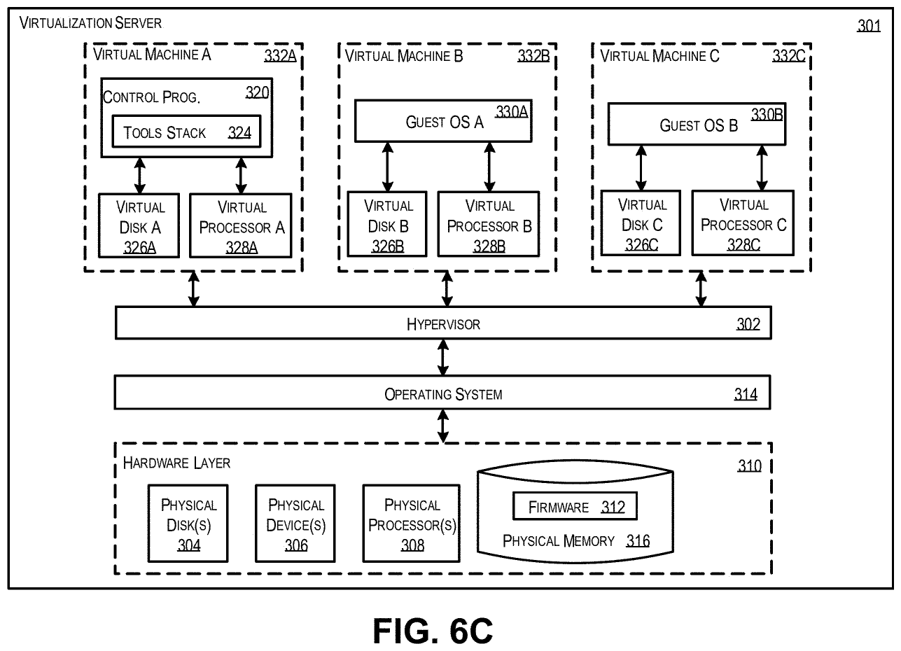

FIG. 6A depicts a network diagram illustrating an example of a network environment 101, in accordance with some example embodiments. Referring to FIGS. 1 and 6A, the network environment 101 in which various aspects of the disclosure may be implemented may include one or more clients 120a-120n, one or more remote machines 106a-106n, one or more networks 104a and 104b, and one or more appliances 108 installed within the network environment 101. The clients 120a-120n communicate with the remote machines 106a-106n via the networks 104a and 104b.

In some example embodiments, the clients 120a-120n may communicate with the remote machines 106a-106n via an appliance 108. The illustrated appliance 108 is positioned between the networks 104a and 104b, and may also be referred to as a network interface or gateway. In some example embodiments, the appliance 108 may operate as an application delivery controller (ADC) to provide clients with access to business applications and other data deployed in a datacenter, the cloud, or delivered as Software as a Service (SaaS) across a range of client devices, and/or provide other functionality such as load balancing and/or the like. In some example embodiments, multiple appliances 108 may be used, and the appliance(s) 108 may be deployed as part of the network 104a and/or 104b.

The clients 120a-120n may be generally referred to as client machines, local machines, clients, client nodes, client computers, client devices, computing devices, endpoints, or endpoint nodes. The clients 120a-120n may include, for example, the first client 120a, the second client 120b, the third client 120c, the fourth client 120d, and/or the like. The remote machines 106a-106n may be generally referred to as servers or a server farm. In some example embodiments, a client 120 may have the capacity to function as both a client node seeking access to resources provided by a server 106 and as a server 106 providing access to hosted resources for other clients 120a-120n. The networks 104a and 104b may be generally referred to as a network 104. The network 104 including the networks 104a and 104b may be configured in any combination of wired and wireless networks.

The servers 106 may include any server type of servers including, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality. The servers 106 may include, for example, the access controller 140 and/or the like.

A server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoW) communications like a soft internet protocol telephone; an application for streaming video and/or audio; an application for facilitating real-time-data communications; a hypertext transfer protocol (HTTP) client; a file transfer protocol (FTP) client; an Oscar client; a Telnet client; or any other set of executable instructions.

In some example embodiments, a server 106 may execute a remote presentation services program or other program that uses a thin-client or a remote-display protocol to capture display output generated by an application executing on a server 106 and transmit the application display output to a client 120.

In yet other example embodiments, a server 106 may execute a virtual machine providing, to a user of a client 120, access to a computing environment. The client 120 may be a virtual machine. The virtual machine may be managed by, for example, a hypervisor, a virtual machine manager (VMM), or any other hardware virtualization technique within the server 106.

In some example embodiments, the network 104 may be a local-area network (LAN), a metropolitan area network (MAN), a wide area network (WAN), a primary public network, and/or a primary private network. Additional embodiments may include one or more mobile telephone networks that use various protocols to communicate among mobile devices. For short-range communications within a wireless local-area network (WLAN), the protocols may include 802.11, Bluetooth, and Near Field Communication (NFC).

FIG. 6B depicts a block diagram illustrating an example of a computing device 600, in accordance with some example embodiments. Referring to FIGS. 1 and 6A-B, the computing device 600 may be useful for practicing an embodiment of the first client 120a, the second client 120b, the third client 120c, the fourth client 120d, and/or the access controller 140.

As shown in FIG. 6B, the computing device 600 may include one or more processors 248, volatile memory 270 (e.g., RAM), non-volatile memory 252 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 254, one or more communications interfaces 256, and a communication bus 258. The user interface 254 may include a graphical user interface (GUI) 260 (e.g., a touchscreen, a display, and/or the like) and one or more input/output (I/O) devices 262 (e.g., a mouse, a keyboard, and/or the like). The non-volatile memory 252 may store an operating system 264, one or more applications 266, and data 268 such that computer instructions of the operating system 264 and/or applications 266 are executed by the processor(s) 248 out of the volatile memory 270. Data may be entered using an input device of the GUI 260 or received from I/O device(s) 262. Various elements of the computing device 600 may communicate via communication the communication bus 258. The computing device 600 as shown in FIG. 6B is shown merely as an example, as the first client 120a, the second client 120b, the third client 120c, the fourth client 120d, and/or the access controller 140 may be implemented by any computing or processing environment and with any type of machine or set of machines that may have suitable hardware and/or software capable of operating as described herein.

The processor(s) 248 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some example embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some example embodiments, the “processor” may be one or more physical processors or one or more “virtual” (e.g., remotely located or “cloud”) processors.

The communications interfaces 256 may include one or more interfaces to enable the computing device 600 to access a computer network such as a local area network (LAN), a wide area network (WAN), a public land mobile network (PLMN), and/or the Internet through a variety of wired and/or wireless or cellular connections.

As noted above, in some example embodiments, one or more computing devices 600 may execute an application on behalf of a user of a client computing device (e.g., the clients 120), may execute a virtual machine, which provides an execution session within which applications execute on behalf of a user or a client computing device (e.g., the clients 120), such as a hosted desktop session, may execute a terminal services session to provide a hosted desktop environment, or may provide access to a computing environment including one or more of: one or more applications, one or more desktop applications, and one or more desktop sessions in which one or more applications may execute.

FIG. 6C depicts a high-level architecture of an example of a virtualization system for implementing the computing system 110, in accordance with some example embodiments. As shown in FIG. 6C, the virtualization system may be a single-server or multi-server system, or a cloud system, including at least one virtualization server 301 configured to provide virtual desktops and/or virtual applications to one or more client access devices 120a-c. As used herein, a desktop may refer to a graphical environment (e.g., a graphical user interface) or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per physical device) or virtual (e.g., many instances of an OS running on a single physical device). Each application may be executed on a local device, or executed on a remotely located device (e.g., remoted).

Virtualization server 301 may be configured as a virtualization server in a virtualization environment, for example, a single-server, multi-server, or cloud computing environment. Virtualization server 301 illustrated in FIG. 6C may be deployed as and/or implemented by one or more embodiments of server 106 illustrated in FIG. 6A or by other known computing devices. Included in virtualization server 301 is hardware layer 310 that may include one or more physical disks 304, one or more physical devices 306, one or more physical processors 308, and one or more physical memories 316. In some embodiments, firmware 312 may be stored within a memory element in physical memory 316 and be executed by one or more of physical processors 308. Virtualization server 301 may further include operating system 314 that may be stored in a memory element in physical memory 316 and executed by one or more of physical processors 308. Still further, hypervisor 302 may be stored in a memory element in physical memory 316 and be executed by one or more of physical processors 308. Presence of operating system 314 may be optional such as in a case where the hypervisor 302 is a Type A hypervisor.

Executing on one or more of physical processors 308 may be one or more virtual machines 332A-C (generally 332). Each virtual machine 332 may have virtual disk 326A-C and virtual processor 328A-C. In some embodiments, first virtual machine 332A may execute, using virtual processor 328A, control program 320 that includes tools stack 324. Control program 320 may be referred to as a control virtual machine, Domain 0, Dom0, or other virtual machine used for system administration and/or control. In some embodiments, one or more virtual machines 332B-C may execute, using virtual processor 328B-C, guest operating system 330A-B (generally 330).

Physical devices 306 may include, for example, a network interface card, a video card, an input device (e.g., a keyboard, a mouse, a scanner, etc.), an output device (e.g., a monitor, a display device, speakers, a printer, etc.), a storage device (e.g., an optical drive), a Universal Serial Bus (USB) connection, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in hardware layer 310 may include any type of memory. Physical memory 316 may store data, and in some embodiments may store one or more programs, or set of executable instructions. FIG. 6C illustrates an embodiment where firmware 312 is stored within physical memory 316 of virtualization server 301. Programs or executable instructions stored in physical memory 316 may be executed by the one or more processors 308 of virtualization server 301.

Virtualization server 301 may also include hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 may be any combination of executable instructions and hardware that monitors virtual machines 332 executing on a computing machine. Hypervisor 302 may be a Type 2 hypervisor, where the hypervisor executes within operating system 314 executing on virtualization server 301. Virtual machines may then execute at a layer above hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on virtualization server 301 by directly accessing the hardware and resources within hardware layer 310. That is, while Type 2 hypervisor 302 accesses system resources through host operating system 314, as shown, a Type 1 hypervisor may directly access all system resources without host operating system 314. A Type 1 hypervisor may execute directly on one or more physical processors 308 of virtualization server 301, and may include program data stored in physical memory 316.

Hypervisor 302, in some embodiments, may provide virtual resources to guest operating systems 330 or control programs 320 executing on virtual machines 332 in any manner that simulates operating systems 330 or control programs 320 having direct access to system resources. System resources can include, but are not limited to, physical devices 306, physical disks 304, physical processors 308, physical memory 316, and any other component included in hardware layer 310 of virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for virtual machine 332 executing on virtualization server 301. Examples of hypervisor 302 may include those manufactured by VMWare, Inc., of Palo Alto, Calif.; Xen Project® hypervisor, an open source product whose development is overseen by the open source XenProject.org community; Hyper-V®, Virtual Server®, and Virtual PC® hypervisors provided by Microsoft Corporation of Redmond, Wash.; or others. The virtualization server 301 may execute hypervisor 302 that creates a virtual machine platform on which guest operating systems 330 may execute. When this is the case, virtualization server 301 may be referred to as a host server. An example of such a virtualization server is Citrix Hypervisor® provided by Citrix Systems, Inc., of Fort Lauderdale, Fla.

Hypervisor 302 may create one or more virtual machines 332B-C (generally 332) in which guest operating systems 330 execute. In some embodiments, hypervisor 302 may load a virtual machine image to create virtual machine 332. The virtual machine image may refer to a collection of data, states, instructions, etc. that make up an instance of a virtual machine. In other embodiments, hypervisor 302 may execute guest operating system 330 within virtual machine 332. In still other embodiments, virtual machine 332 may execute guest operating system 330.

In addition to creating virtual machines 332, hypervisor 302 may control the execution of at least one virtual machine 332. The hypervisor 302 may present at least one virtual machine 332 with an abstraction of at least one hardware resource provided by virtualization server 301 (e.g., any hardware resource available within hardware layer 310). In some implementations, hypervisor 302 may control the manner in which virtual machines 332 access physical processors 308 available in virtualization server 301. Controlling access to physical processors 308 may include determining whether virtual machine 332 should have access to processor 308, and how physical processor capabilities are presented to virtual machine 332.

As shown in FIG. 6C, the virtualization server 301 may host or execute one or more virtual machines 332. Virtual machine 332 may be a set of executable instructions and/or user data that, when executed by processor 308, may imitate the operation of a physical computer such that virtual machine 332 can execute programs and processes much like a physical computing device. While FIG. 6C illustrates an embodiment where virtualization server 301 hosts three virtual machines 332, in other embodiments virtualization server 301 may host any number of virtual machines 332. Hypervisor 302 may provide each virtual machine 332 with a unique virtual view of the physical hardware, including memory 316, processor 308, and other system resources 304, 306 available to that virtual machine 332. The unique virtual view may be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to virtual machines 332.

Each virtual machine 332 may include virtual disk 326A-C (generally 326) and virtual processor 328A-C (generally 328.) Virtual disk 326 may be a virtualized view of one or more physical disks 304 of virtualization server 301, or a portion of one or more physical disks 304 of virtualization server 301. The virtualized view of physical disks 304 may be generated, provided, and managed by hypervisor 302. In some embodiments, hypervisor 302 may provide each virtual machine 332 with a unique view of physical disks 304. These particular virtual disk 326 (included in each virtual machine 332) may be unique, when compared with other virtual disks 326.

Virtual processor 328 may be a virtualized view of one or more physical processors 308 of virtualization server 301. The virtualized view of physical processors 308 may be generated, provided, and managed by hypervisor 302. Virtual processor 328 may have substantially all of the same characteristics of at least one physical processor 308. Virtual processor 308 may provide a modified view of physical processors 308 such that at least some of the characteristics of virtual processor 328 are different from the characteristics of the corresponding physical processor 308.

One or more aspects or features of the subject matter described herein can be realized in digital electronic circuitry, integrated circuitry, specially designed application-specific integrated circuit (ASIC), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one data processor; and
at least one memory storing instructions, which when executed by the least one data processor, cause the at least one data processor to at least:
receive, from a first client device, a first request for an authorization of one or more actions of a first user at the first client device, the one or more actions affecting a computing system;
respond to the first request by at least sending, to a second client device, a second request for a second user at the second client device to authorize the one or more actions of the first user;
receive, from the second client device, a first indication that the second user authorizes the one or more actions, the first indication including an acknowledgement of a threshold quantity of the one or more actions; and
respond to the first indication by at least executing, at the computing system, the one or more actions.

2. The system of claim 1, wherein the at least one data processor is further caused to at least:
in response to the second user at the second client device failing to acknowledge the threshold quantity of the one or more actions, decline to execute, at the computing system, the one or more actions.

3. The system of claim 1, wherein the at least one data processor is further caused to at least:
receive, from the second client device, a second indication of the second user declining to authorize the one or more actions; and
respond to the second indication by at least declining to execute, at the computing system, the one or more actions.

4. The system of claim 1, wherein the at least one data processor is further caused to at least:
in response to the second user at the second client device failing to respond to the second request within a threshold quantity of time, decline to execute, at the computing system, the one or more actions.

5. The system of claim 1, wherein the at least one data processor is further caused to at least:
receive, from the second client device, a second indication of the second user terminating the authorization of the one or more actions; and
respond to the second indication by at least declining to execute, at the computing system, the one or more actions.

6. The system of claim 1, wherein the first request comprises a request to identify one or more pools of available peer reviewers.

7. The system of claim 6, wherein the at least one data processor is further caused to at least:
in response to a selection of a pool of available peer reviewers that includes the second user and a third user, send, to the second client device and a third client device of the third user, the second request to authorize the one or more actions of the first user.

8. The system of claim 1, wherein the first request comprises a request to identify one or more available peer reviewers, and wherein the second request is sent to the second client device in response to a selection of the second user from the one or more available peer reviewers.

9. The system of claim 1, wherein the at least one data processor is further caused to at least:
receive, from the first client device, a third request to access the computing system;
respond to the third request by at least sending, to the second client device or a third client device of a third user, a fourth request to verify an identity of the first user; and
authenticate, based at least on the second user or the third user verifying the identity of the first user, the first user.

10. The system of claim 1, wherein executing the one or more actions modifies the computing system including by adding and/or removing one or more of a user and a service of the computing system.

11. A computer-implemented method, comprising:
receiving, from a first client device, a first request for an authorization of one or more actions of a first user at the first client device, the one or more actions affecting a computing system;
responding to the first request by at least sending, to a second client device, a second request for a second user at the second client device to authorize the one or more actions of the first user;
receiving, from the second client device, a first indication that the second user authorizes the one or more actions, the first indication including an acknowledgement of a threshold quantity of the one or more actions; and
responding to the first indication by at least executing, at the computing system, the one or more actions.

12. The method of claim 11, further comprising:
in response to the second user at the second client device failing to acknowledge the threshold quantity of the one or more actions, declining to execute, at the computing system, the one or more actions.

13. The method of claim 11, further comprising:
receiving, from the second client device, a second indication of the second user declining to authorize the one or more actions; and
responding to the second indication by at least declining to execute, at the computing system, the one or more actions.

14. The method of claim 11, further comprising:
in response to the second user at the second client device failing to respond to the second request within a threshold quantity of time, declining to execute, at the computing system, the one or more actions.

15. The method of claim 11, further comprising:
receiving, from the second client device, a second indication of the second user terminating the authorization of the one or more actions; and
responding to the second indication by at least declining to execute, at the computing system, the one or more actions.

16. The method of claim 11, wherein the first request comprises a request to identify one or more pools of available peer reviewers.

17. The method of claim 16, further comprising:
in response to a selection of a pool of available peer reviewers that includes the second user and a third user, sending, to the second client device and a third client device of the third user, the second request to authorize the one or more actions of the first user.

18. The method of claim 11, wherein the first request comprises a request to identify one or more available peer reviewers, and wherein the second request is sent to the second client device in response to a selection of the second user from the one or more available peer reviewers.

19. The method of claim 11, further comprising:
receiving, from the first client device, a third request to access the computing system;
responding to the third request by at least sending, to the second client device or a third client device of a third user, a fourth request to verify an identity of the first user; and
authenticating, based at least on the second user or the third user verifying the identity of the first user, the first user.

20. A non-transitory computer readable medium storing instructions, which when executed by at least one data processor, result in operations comprising:
receiving, from a first client device, a first request for an authorization of one or more actions of a first user at the first client device, the one or more actions affecting a computing system;
responding to the first request by at least sending, to a second client device, a second request for a second user at the second client device to authorize the one or more actions of the first user;
receiving, from the second client device, a first indication that the second user authorizes the one or more actions, the first indication including an acknowledgement of a threshold quantity of the one or more actions; and
responding to the first indication by at least executing, at the computing system, the one or more actions.
